(19) United States
(12) Patent Application Publication
(10) Pub. No.: US 2009/0296273 A1
(43) Pub. Date: Dec. 3, 2009

(54) INFORMATION RECORDING APPARATUS

(75) Inventor: Kiyoto Kurashima, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/430,664

(22) Filed: Apr. 27, 2009

(30) Foreign Application Priority Data
May 27, 2008 (JP) 2008-138556
Feb. 13, 2009 (JP) 2009-031863

(51) Int. Cl. G11B 33/14

(52) U.S. Cl. 360/97.02; G9B/33.035

(57) ABSTRACT

An information recording apparatus includes a recording medium and a flying head for writing/reading information on the recording medium, arranged in a housing, in which a mass sensor is arranged in a path of an air flow inside the housing due to spinning of the recording medium. The output of the mass sensor is monitored by a monitoring circuit.

### CROSS-REFERENCE TO RELATED APPLICATION

This application is based upon and claims the benefit of priority of the prior Japanese Patent Applications No. 2008-138556, filed on May 27, 2008, and No. 2009-31863, filed on Feb. 13, 2009, the entire contents of which are incorporated herein by reference.

### FIELD

The present invention relates to an information recording apparatus having a spinning recording medium.

### BACKGROUND

A magnetic disk apparatus used for a computer external storage system etc. utilizes the flow of air created by the high speed spinning of a magnetic disk to make the recording and reproduction head float. Further, an actuator is used to position the recording and reproduction head to a desired track for recording or reproduction of data.

The magnetic disk and the recording and reproduction head maintain a very slight clearance between them by floating during operation of the magnetic disk apparatus. If dust particles or other particles enter this clearance, the recording and reproduction element of the recording and reproduction head sometimes deteriorates or the disk is sometimes damaged. If the recording and reproduction device deteriorates or the disk is damaged, information recorded on the disk cannot be read, the recorded information is destroyed, or other problems occur. In the worst case, the disk apparatus as a whole may crash becoming unable to be used. Every year, recording densities are rising and the clearances between heads and disks are becoming narrower, so problems may be caused even by smaller particles.

Note that in the past, it has been proposed to monitor the change in the amount of gas, the cause of generation of particles, in the container of the hard disk magnetic recording medium (see Japanese Patent Publication (A) No. 2007-35180).

### SUMMARY

According to an aspect of the invention, an information recording apparatus includes a housing, at least one spinning recording medium and a head facing the recording medium and writing/reading information on the recording medium arranged in the housing, at least one mass sensor detecting particulate matter arranged in a path of air flowing through the housing along with spinning of the recording medium, and a monitoring circuit monitoring output from the mass sensor.

The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

The object and features of the present invention will become clearer from the following description of the preferred embodiments given with reference to the attached drawings, wherein:

FIG. 1 is a view depicting an operation of an example of a mass sensor used in the present embodiment;

FIG. 2 is a view depicting an example of a disk apparatus according to the present embodiment;

FIG. 3 is a view depicting results of simulation of an air flow in a disk enclosure of FIG. 2;

FIG. 4 is a view depicting another example of a disk apparatus according to the present embodiment;

FIG. 5 is a view depicting an example of measurement of particles generated in a disk apparatus;

FIG. 6 is a view depicting mass sensors arranged among a plurality of disk media;

FIG. 7 is a view depicting the general configuration for monitoring the environment inside a disk enclosure according to the present embodiment;

FIG. 8 is a view depicting an example of output of a mass sensor according to the present embodiment;

FIG. 9 is a view depicting another example of output of a mass sensor according to the present embodiment; and

FIG. 10 is a view showing the flow of operation for monitoring the environment inside a disk enclosure according to the present embodiment.

### DESCRIPTION OF EMBODIMENTS

Below, an embodiment will be explained with reference to the drawings.

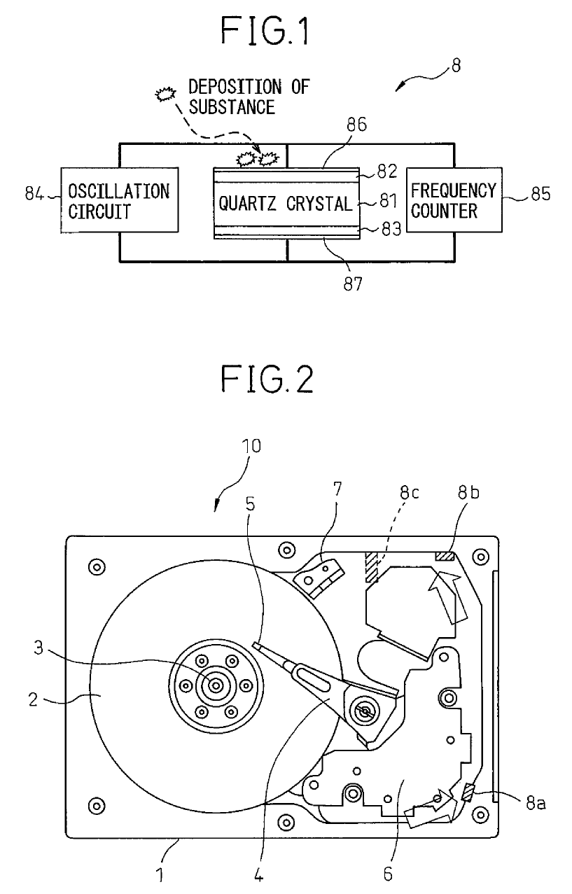

FIG. 1 is a view for explaining the operation of a mass sensor monitoring dust particles in the present embodiment. In the present embodiment, the mass sensor for monitoring the dust particles is not limited to a specific sensor, but for example there is a quartz crystal microbalance (QCM) sensor using the QCM method, an elastic microsensor using surface acoustic waves, a mass sensor using a micro electro mechanical system (MEMS), etc.

FIG. 1 illustrates a QCM sensor 8 having a mass sensor used in the present embodiment. The QCM sensor 8 has a quartz crystal 81 sandwiched between silver electrodes 82 and 83 connected to an oscillation circuit 84 for making the quartz crystal 81 resonate. If some substance deposits on the silver electrodes 82 and 83 sandwiching the quartz crystal 81, due to the addition of the mass of the substance, the resonance frequency of the vibrating quartz crystal 81 changes. By detecting the change of the resonance frequency by the frequency counter 85, the deposition of the substance can be determined. The silver electrodes 82 and 83 can be provided with coating layers 86 and 87 on their surfaces.

FIG. 2 is a view illustrating an example of a magnetic disk apparatus at which mass sensors according to the present embodiment are arranged. FIG. 2 illustrates a magnetic disk apparatus 10 removing a top cover. A magnetic recording medium, that is, a disk medium 2, is rotatably supported at a spindle motor 3 fixed to the housing, that is, a disk enclosure 1. A head 5 writing/reading information on the disk medium is arranged at a front end of an actuator 4 so as to face the disk medium. The actuator 4 is fixed to the disk enclosure 1 so as to be able to move in the substantially radial direction of the disk medium by a voice coil 6. The magnetic disk apparatus 10 is a load/unload type, so a ramp 7 is provided near the outside of the disk medium 2. When the disk apparatus is stopped, the actuator 4 retracts from the disk medium 2 and is placed on the ramp 7. The load/unload type differs from the contact start stop (CSS) type in that the head 5 and disk medium 2 never come into contact.

In the present embodiment, mass sensors 8a to 8c are arranged to detect the generated particles. The mass sensors 8a and 8b are attached by being adhered to corners of the inside walls of the enclosure 1. The mass sensor 8c is placed at an intermediate part of the inner walls of the enclosure 1 instead of the mass sensors 8a and 8b. The mass sensor 8c arranged at the intermediate part of the inner wall of the enclosure 1 is arranged sticking out from the inner walls.

While the magnetic disk apparatus 10 is operating, the disk medium 2 spins at a high speed. The flow of air produced by the high speed spinning causes the head 5 to float. The head 5 is positioned at a desired track by the actuator 4 for writing/reading data. The particles generated in the enclosure flow along the air flow and deposits on the mass sensors 8a and 8b or the mass sensor 8c arranged in the passage of the air flow indicated by the arrow of FIG. 2.

The deposited particles cause the outputs of the mass sensors 8a and 8b, or 8c to change. When the amounts of change of the outputs of the mass sensors 8a and 8b, or 8c are larger than a predetermined threshold value, an alarm is issued. Further, the head 5 is retracted from the data region of disk medium 2 and placed on the ramp 7. In this way, it is possible to quickly detect generated particles and possible to take desired action.

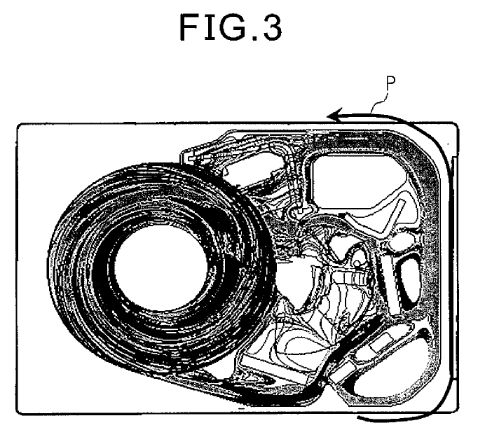

FIG. 3 is a view illustrating the results of simulation of the air flow produced in the magnetic disk apparatus of FIG. 2. The disk medium spins at a high speed in the counterclockwise direction. Part of the air flow produced due to the high speed spinning proceeds from above the disk medium along the bottom inner wall in FIG. 2 in the right direction. As indicated by the arrow P, the air flow proceeding along the bottom inside wall of FIG. 2 further heads along the right inside wall of FIG. 2 from the bottom to the top of the figure, proceeds in the left direction along the top inside wall of FIG. 2, and merges with the air flow on the disk medium.

As is evident from the results of simulation of FIG. 3, it is sufficient to arrange the mass sensors at positions struck by the air flow in the enclosure. In the present embodiment, considering whether the mass sensors can be easily arranged, as illustrated in FIG. 2, the mass sensors 8a and 8b are attached at the corners of the inside walls of the enclosure 1 or the sensor 8c is arranged sticking out from the inside walls of the enclosure 1. When making a sensor stick out from the inside walls of the enclosure 1, it is preferable to arrange it in a direction as possible as perpendicular to the inside walls.

In the example illustrated in FIG. 2, the mass sensors 8a and 8b, or 8c are arranged, but it is sufficient that even a single mass sensor be provided. For example, it is also possible to arrange just the mass sensor 8a. Further, it is possible to arrange all of the mass sensors 8a to 8c. Further, it is also possible to arrange four or more. Further, the locations of placement of the mass sensors may also be suitably selected. Further, for example, it is possible to use the mass sensors 8a and 8c or use two or more mass sensors sticking out from the inner walls. In addition, they may be arranged anywhere inside the air flow. The type of the mass sensors may be suitably selected. The types of the mass sensors may be changed in accordance with the locations of placement.

In FIG. 2, a load/unload type magnetic disk apparatus having a ramp 7 was explained, but it is also possible to arrange mass sensors in the same way at a CSS type magnetic disk not provided with a ramp 7. With a CSS type magnetic disk, when the alarm is issued, the head is retracted from the data region of the disk medium and placed at a landing zone at the inside circumference of the disk medium.

FIG. 4 is a view of another example of a magnetic disk apparatus at which the mass sensors according to the present embodiment are arranged. Parts having the same functions as those in FIG. 2 are assigned the same reference numerals. In the magnetic disk illustrated in FIG. 4, the flow of the air in the enclosure 1 differs from that of FIG. 2. Corresponding to the difference in the flow path, in FIG. 4, mass sensors 8e to 8g are arranged. The mass sensors 8e and 8f are arranged adhered at the corners of the inside walls in the same way as in FIG. 2. The mass sensor 8g is arranged adhered to the illustrated left corner so as to receive the air flow indicated by the arrow. Whatever the case, it is arranged so as to directly face the air flow in the air flow in the enclosure so as to reliably trap the particles carried on the air flow.

The mass sensor 8h is a sensor arranged so as to stick out from the center part of the inside walls of the enclosure 1. The mass sensor 8h may be used instead of the mass sensors 8e to 8g. Furthermore, it may be used together with the mass sensors 8e to 8g. The number, locations of placement, types, and combinations of the mass sensors may be suitably selected as explained above.

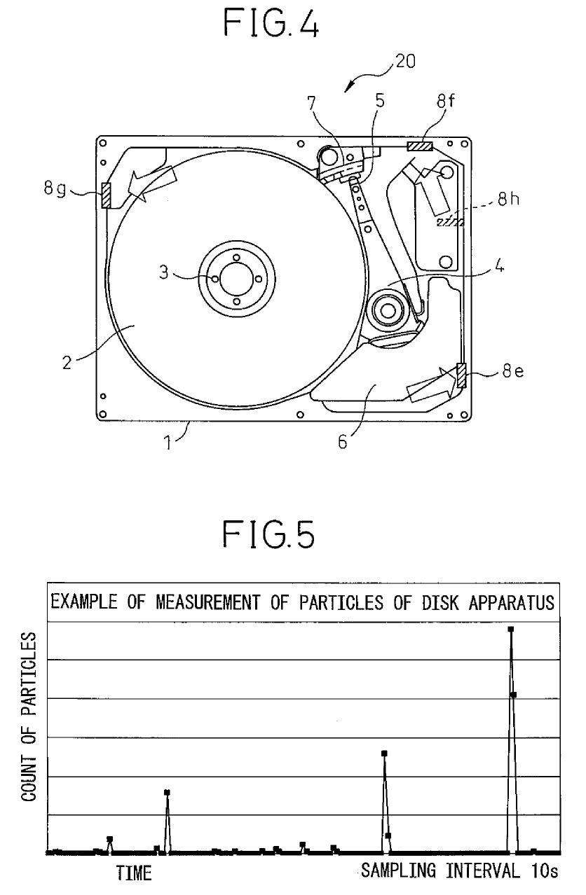

FIG. 5 is a view depicting an embodiment of the particles produced in an enclosure of a disk apparatus. The abscissa of the graph shown in FIG. 5 is the time axis. The sampling intervals of the measurement are 10 seconds. The ordinate shows the count of the particles produced.

Almost all of the particles generated in the enclosure of the disk apparatus are adsorbed at a particle removing filter (not shown) arranged in the enclosure and removed in a relatively short time of several milliseconds to several tens of seconds. In the example of FIG. 5, the particles disappear at most 30 seconds or so from the generation of the particles. However, the short interval from when particles are generated to when the number of particles is reduced by adsorption is dangerous. During the short interval, if the particles reach the clearance between the head and recording medium, the data will be destroyed or the head will crash in some cases.

In the present embodiment, the generated particles are detected by the mass sensors while the particles are carried on the air flow, so it is possible to detect particles early and to reduce the possibility of data destruction or head crashing.

In this regard, the contaminating substances generated in an enclosure include not only particles, but also gaseous substances. In the usual usage state, the gaseous substances in the disk apparatus are extremely light. For changes in the gaseous substances to have an effect on reliability, at least several hours or several days are required. The present embodiment exhibits effects for particles which can have a large effect in a short interval as explained above.

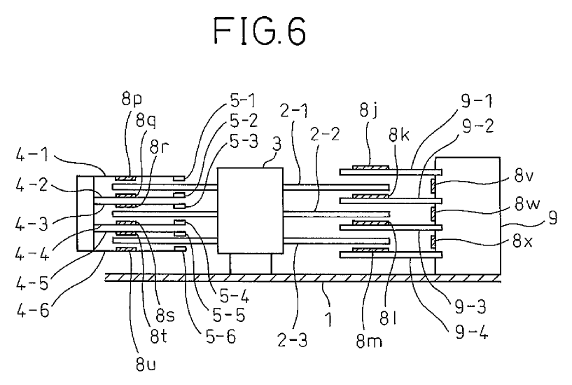

FIG. 6 is a view depicting an example of arrangement of the mass sensors according to the present embodiment near the disk medium. As illustrated in FIG. 6, the magnetic disk apparatus is often provided with a plurality of disk media 2-1 to 2-3 rotatably supported at the spindle. Between the plurality of disk media 2-1 to 2-3, spoilers 9-1 to 9-4 are arranged for straightening the air flow or suppressing vibration of the medium. To effectively monitor the particles generated near the disk media 2, mass sensors 8j to 8m are arranged on the top surfaces of the spoilers. The outer circumferences of the disk media are fast in circumferential speed and large in flow rate of the air, so the mass sensors 8j to 8m are preferably arranged near the outer circumferences of the disk media. Further, the mass sensors 8j to 8m can be arranged at the bottom surfaces of the spoilers.

Note that, instead of the mass sensors 8j to 8m, it is possible to use mass sensors 8v to 8x arranged between the spoilers 9-1 to 9-4 of a spoiler support 9.

Furthermore, it is also possible to arrange mass sensors 8p to 8u at the actuators 4-1 to 4-6 having heads 5-1 to 5-6 for writing/reading information with respect to the disk media. In this case as well, the mass sensors 8p to 8u are arranged near the outer circumferences of the disk media 2. In this example, the mass sensors 8p to 8u are arranged at the bottom surfaces of the actuators 4-1 to 4-6, but they may also be arranged at the top surfaces of the actuators 4-1 to 4-6.

Note that, FIG. 6 only illustrates the locations where the mass sensors can be arranged. The number of the disk media 2 and the positional relationship of the actuators 4-1 to 4-6 and spoilers 9-1 to 9-4 are not limited.

When placing mass sensors on spoilers or actuators, it is preferable to place them near the outer circumferences of the media where the peripheral speed of the recording media is fast and the flow rate of the air enclosed in the disk apparatus is large. Further, the mass sensors may also be arranged at the side of the spoilers or actuators directly struck by the air flowing together with spinning of the disk media, that is, the upstream side.

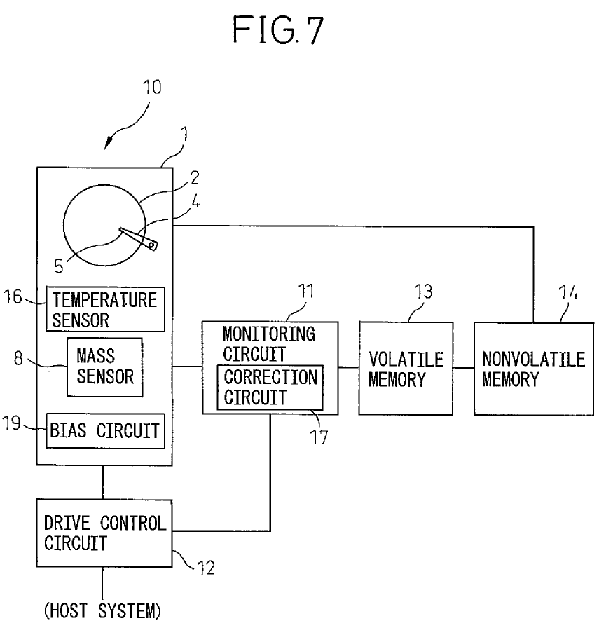

FIG. 7 is a block diagram illustrating an outline of the disk apparatus of the present embodiment. In FIG. 7, the structure in the disk enclosure 1 is omitted and only specific members are illustrated. The disk enclosure 1 having a disk medium 2, an actuator 4 having a head 5, and a mass sensor 8 is connected to the drive control circuit 12 for drive control. The drive control circuit 12 is for example connected to a host apparatus such as a personal computer or a host system.

The monitoring circuit 11 receives as input a detection signal of the mass sensor 8 and monitors for the generation of particles. The detection signal periodically output from the mass sensor 8 is recorded in the volatile memory 13 for temporary data storage. The recording period of data to the volatile memory may be made as short a period as possible, but may be suitably set considering various conditions. Further, it is also possible to set a normal mode setting the period of predetermined regular recording to be longer than the shortest period and an abnormal mode enabling recording by a shorter period than the regular period when an abnormal value is confirmed. Further, it is also possible to set the abnormal mode to two stages or otherwise give recording modes having three or more periods and hold the data.

Further, to go back and find the changes in the mass sensor 8, the detection data is recorded from a volatile memory 13 to a nonvolatile memory 14. Furthermore, it is also possible to record data from the nonvolatile memory 14 to the disk medium 2 while considering the storage capacity of the memory mounted in the disk apparatus, the recording period of the data, etc.

A temperature sensor 16 is arranged in the disk enclosure 1 to detect the change of temperature due to the heat generated by the usage environment of the disk apparatus or the disk apparatus itself and the correction circuit 17 in the monitoring circuit 11 is used to correct the output of the mass sensor 8. By correcting the output of the mass sensor 8, it is possible to improve the detection precision.

It is generally known that particles are charged to a plus state in a state floating in the air. In the present embodiment, a bias voltage application circuit 19 is arranged in the disk enclosure and the bias voltage application circuit 19 is used to charge the surface of the mass sensor 8 to a minus state and adsorb the particles charged to a plus state. The applied voltage of the bias voltage application circuit 19 can be freely changed, so it is possible to adjust the adsorption characteristics.

Further, to make the mass sensor surface an easily minus charged state, for example it is also possible to coat it with Teflon®, polyethylene acryl, or another material with a high electron acceptability. By using a material having a high electron acceptability as the coating layer 86, 87 shown in FIG. 1, the sensor surface is easily charged to a minus state and the plus charged particles can be selectively adsorbed. Coating by a material with a high electron acceptability can also be used together with application of a bias voltage.

It is possible to use the bias voltage application circuit 19 to charge the mass sensor 8 to a plus state and selectively adsorb minus charged particles. To selectively adsorb minus charged particles, it is possible to form the coating layers 86 and 87 on the electrodes of the mass sensor 8 by, for example, Nylon, rayon, or another material easily emitting electrons. By the coating layers of materials easily emitting electrons, the sensor surface becomes a plus charge and the minus charged particulate matter can be selectively adsorbed. Coating by a material easily emitting electrons and using a bias voltage application circuit 19 to charge the surface of the mass sensor 8 to a plus state can be used together.

Note that, in FIG. 7, the monitoring circuit 11 is arranged outside the disk enclosure 1, but it may also be arranged inside the disk enclosure 1. Further, the bias voltage application circuit may also be arranged inside the monitoring circuit 11.

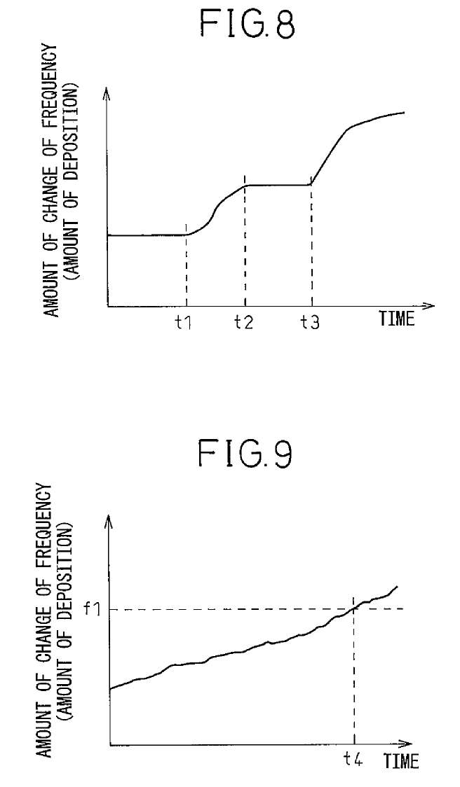

FIG. 8 is a view explaining an example of the change of frequency of the output of the mass sensor. Particles deposit on the silver electrodes of the QCM sensor of the mass sensor whereby the mass increases, the resonance frequency decreases, and the amount of change of the frequency increases. According to FIG. 8, the particles rapidly deposit from the time t1. Particulate matter such as particles is relatively large in mass. When deposited on the surface of the mass sensor, the amount of change of the frequency is large. Therefore, by detecting the amount of deposition using the amount of change of the frequency of the mass sensor per unit time, it is possible to quickly detect the particulate matter generated in the disk enclosure.

The amount of change of the frequency is compared with a predetermined threshold value. If over the threshold value, an alarm is issued and the sensor is retracted from the operating position of the disk medium thereby avoiding the problems of particles being caught between the head and disk. The method of making the head retract from the operating position of the disk medium to outside the data region of the disk medium differs depending on the type of the disk apparatus. The CSS type disk apparatus makes the head retract to inside the innermost data region. The load/unload type disk apparatus removes the head from the disk surface and places it on a ramp placed near the disk.

The particles deposited on the silver electrodes remain as deposited and will not drop off, so if no change is observed from the time t2 on, it is learned that no new particles are generated. Therefore, when the head is retracted due to a rapid change of the frequency from t1 or more, it is possible to cancel the retraction of the head in a suitable time from t2 on. However, at t3, rapid change is shown, so the head is retracted.

FIG. 9 is a view for explaining another example of the change of frequency of the output of the mass sensor. As illustrated in FIG. 9, sometimes there is no sudden change of the particles and the frequency gradually increases. At such a time, rather than the amount of change of the frequency, it is possible to use the frequency value corresponding to the cumulative value of the particles deposited on the sensor as the indicator of the environment inside the disk enclosure. When using the cumulative value of the particles as an indicator, for example, a frequency giving the threshold value is set in advance as indicated by f1 in FIG. 8 and the disk apparatus is set so as to shift to the alarm state when the sensor output exceeds the threshold value f1. Note that it is also possible to combine the amount of change of the frequency and value of the frequency for use as an indicator of the environment inside the disk enclosure.

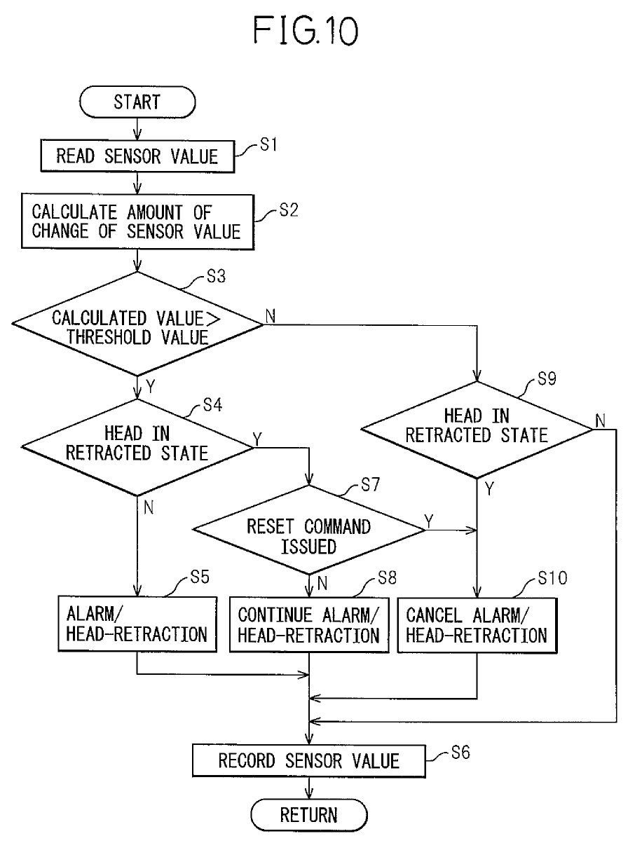

FIG. 10 is a view depicting an example of a flow chart for controlling the writing/reading of information to and from a disk medium by output of a mass sensor. When the disk apparatus 10 is activated and the disk 2 starts to spin at a high speed, the detection value of the mass sensor 8, that is, the sensor value, is periodically read by the monitoring circuit 11 (S1). The monitoring circuit 11 obtains the difference of the sensor value right before from the obtained sensor value and calculates the amount of change of the sensor value (S2).

Next, the calculated sensor value is compared with a predetermined threshold value (S3). If the particles rapidly is generated and the calculated value of the amount of change of the frequency of the mass sensor 8 becomes larger than a threshold value, it is judged if the head 5 is in the retracted state (S4). If not in the retracted state, an alarm is issued and the head 5 is automatically made to retract outside of the data region (S5).

In the present embodiment, an alarm is issued to the host system through the drive control circuit 12. Therefore, a manager receiving the alarm can obtain a grasp of the danger of the information recorded in the disk apparatus 10 being destroyed, so it is possible to take countermeasures such as backing up data from the disk apparatus 10 in accordance with the danger, replacing the disk 2, etc.

In the flow of FIG. 10, an alarm is issued and the head 5 is made to automatically retract outside of the data region, but it is also possible to only issue an alarm. For example, when setting a plurality of threshold values and taking countermeasures in accordance with the degree of risk, when the degree of risk is low, it is possible to only issue an alarm and not automatically make the head 5 retract out of the data region.

When the measure according to step S5 ends, the sensor value is recorded (S6) and the routine returns to step S1. At step S6, the calculated amount of change can also be recorded. The data of the sensor value can be recorded in the form of recording the cumulative operating time and sensor value at one address. Further, it can be managed by making the normal regular data storage region and data storage region at the time of an abnormality different.

At step S4, if the head is in the retracted state, it is checked if a forced reset command has been issued or not (S7). The case where the head is in the retracted state includes the state where there had previously been rapid generation of particles and the head was retracted from the operating position of the disk. The forced reset command is a command for forcibly resetting the disk apparatus to the normal mode even if the disk apparatus 10 is in the alarm state and the head 5 is retracted. For example, when desiring to read important data or when desiring to operate the disk apparatus even if risky, the forced reset command can be used.

At step S7, if a forced reset command is issued, the routine proceeds to step S10 where the alarm and head retraction are cancelled and the normal mode is reset. After this, the sensor value is recorded (S6) and the routine returns to step S1.

At step S3, if it is judged that the calculated value of the amount of change of frequency does not exceed the threshold value, that is, the generation of particles is small, it is judged if the head 5 is in a state retracted from the operating position of the disk medium 2 (S9). If not in the retracted state, the sensor value is recorded at step S6 and the routine returns to step S1.

At step S9, if the head 5 is retracted from the operating position of the disk medium 2, the alarm is cancelled, the retraction of the head is cancelled, and the normal mode is returned to (S10). After that, the sensor value/calculated value is recorded (S5), then the routine returns to step S1.

The present embodiment detects the generation of particles and makes the head retract, so it is possible to prevent the disk apparatus from crashing or the data being destroyed. Further, even while the head is retracted from the data region on the medium, the mass sensor continues monitoring. When in the alarm state, it maintains the retracted state of the head. When falling below the judgment criteria along with the elapse of time, the alarm state is lifted and the normal operation mode is reset. Furthermore, even during continuation of the alarm, by reading the value of the mass sensor, the manager of the disk apparatus or host system can learn of the current status inside the disk apparatus.

At step S3 of the flow of operation of FIG. 10, it was explained that an alarm was issued by monitoring the amount of change of frequency output by the mass sensor, but it is also possible to monitor the frequency value corresponding to the amount of deposition of particles. That is, it is also possible to issue an alarm when the frequency value exceeds a predetermined value.

According to the present embodiment, by detecting the generation of particles, it is possible to detect in advance the possibility of destruction of the head or medium called “crashing” and physical damage to the head or partial destruction of the data due to caught particles etc.

Further, since the disk apparatus itself automatically makes the head retract from the data storage region, it is possible to keep the phenomenon of information recorded on the disk apparatus becoming unreadable or the possibility of information being destroyed to a minimum.

Furthermore, since the state of dirt inside the disk enclosure is periodically recorded, it is possible to read past information to determine the current state of the disk apparatus and possible to take desired countermeasures even without an alarm.

In the present embodiment, the explanation was given with reference to a magnetic disk apparatus, but it is possible to apply the present embodiment to not only a magnetic disk apparatus, but any apparatus storing information in a spinning recording medium such as an optical disk, opto-magnetic disk, etc.

All examples and conditional language recited herein after intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. An information recording apparatus comprising:
a housing,
at least one spinning recording medium and a head facing the recording medium and writing/reading information on the recording medium arranged inside the housing,
at least one mass sensor detecting particles arranged in a path of an air flow flowing inside the housing along with spinning of the recording medium, and
a monitoring circuit monitoring output from the mass sensor.

2. The information recording apparatus as set forth in claim 1, wherein the mass sensor is arranged at an inside wall corner of the housing.

3. The information recording apparatus as set forth in claim 1, wherein the mass sensor is arranged sticking out from an inside wall of the housing.

4. The information recording apparatus as set forth in claim 1, wherein a plurality of recording media are supported at intervals on a coaxial rotary shaft, and mass sensors are mounted on members arranged between the recording media.

5. The information recording apparatus as set forth in claim 1, wherein the mass sensor is mounted on an actuator supporting the writing/reading head.

6. The information recording apparatus as set forth in claim 1, wherein the monitoring circuit issues an alarm when an amount of change of output of the mass sensor exceeds a predetermined threshold value.

7. The information recording apparatus as set forth in claim 6, wherein the monitoring circuit further makes the writing/reading head retract from a data region of the recording medium.

8. The information recording apparatus as set forth in claim 1, further comprising a nonvolatile memory, wherein an output of the mass sensor is recorded at least one of the nonvolatile memory and the recording medium.

9. The information recording apparatus as set forth in claim 1, further comprising a circuit applying a bias voltage of a predetermined polarity to the mass sensor.

10. The information recording apparatus as set forth in claim 1, wherein the mass sensor includes a covering layer formed by a material with a high donor acceptability.
